(19) United States
(12) Patent Application Publication
(10) Pub. No.: US 2018/0135741 A1
(43) Pub. Date: May 17, 2018

(54) FLUID SUPPLY OVER RANGE OF GRAVITATIONAL CONDITIONS

(71) Applicant: United Technologies Corporation, Farmington, CT (US)

(72) Inventor: JinQuan Xu, East Greenwich, RI (US)

(21) Appl. No.: 15/350,754

(22) Filed: Nov. 14, 2016

(51) Int. Cl. F16H 57/04; F16N 17/00; F16N 7/38

(52) U.S. Cl. CPC F16H 57/0443; F16H 57/045; F16N 2210/09; F16N 7/38; F16H 57/0486; F16N 17/00

(57) ABSTRACT

Aspects of the disclosure are directed to a system comprising: a tank that stores a fluid, and a conduit that includes a first end and a second end, where the conduit is configured to convey at least a portion of the fluid stored in the tank from the second end of the conduit to the first end of the conduit, where a first end region of the conduit coinciding with the second end of the conduit has a first end region density and the fluid has a fluid density, where the first end region density is greater than or equal to the fluid density such that the first end region of the conduit remains immersed in the fluid stored in the tank when the fluid in the tank is under negative gravity conditions.

### BACKGROUND

Gas turbine engines, such as those which power aircraft and industrial equipment, employ a compressor to compress air that is drawn into the engine and a turbine to capture energy associated with the combustion of a fuel-air mixture. At least on an aircraft, an engine may assume various positions/attitudes and may be subject to various forces over the operational lifetime of the engine.

United States patent application publication number 2014/0076661 A1 (the contents of which are incorporated herein by reference; hereinafter referred to as the '661 publication) describes systems/architectures for providing lubricant to various components (e.g., journal pins, gears, etc.) of the engine, regardless of the environmental conditions in which the engine is operating. As described in the '661 publication, it may be desirable to ensure that those components are not starved of lubricant (e.g., that the components/sub-systems receive lubricant in an amount that is greater than a threshold) during reduced-G conditions in which acceleration due to the Earth's gravitational field is partially or entirely counteracted by aircraft maneuvers and/or orientation, such as for example during free-fall brought on by a loss of engine power. Reduced-G conditions include, for example, negative gravity (also referred to herein as negative-G), zero gravity (also referred to herein as zero-G), and positive gravity (also referred to herein as positive-G) conditions materially less than about 9.8 meters/sec/sec. Failure to ensure that the threshold supply of lubricant is provided to a component during, e.g., reduced-G conditions may render the component inoperable. Thus, what is needed are improved techniques for providing at least a threshold amount of lubricant to one or more components of the engine, inclusive of when the engine is operating in reduced-G conditions.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system comprising: a tank that stores a fluid, and a conduit that includes a first end and a second end, where the conduit is configured to convey at least a portion of the fluid stored in the tank from the second end of the conduit to the first end of the conduit, where a first end region of the conduit coinciding with the second end of the conduit has a first end region density and the fluid has a fluid density, where the first end region density is greater than or equal to the fluid density such that the first end region of the conduit remains immersed in the fluid stored in the tank when the fluid in the tank is under negative gravity conditions. In some embodiments, the fluid includes at least one of hydraulic fluid, fuel, or refrigerant. In some embodiments, the fluid includes a lubricant. In some embodiments, the first end of the conduit is in fluid communication with a mechanism that draws at least a portion of the lubricant from the tank. In some embodiments, the system further comprises a mass coupled to the second end of the conduit. In some embodiments, the first end region density is a collective density of a density of the conduit at the second end of the conduit and a density of the mass. In some embodiments, the system further comprises a pole coupled to the mass, where the mass is limited to movement along a span of the pole. In some embodiments, a first end of the pole is coupled to a first end of the tank, and where a second end of the pole is coupled to a second end of the tank. In some embodiments, at least one of the first end of the pole or the first end of the tank is fitted with a first stop, and where at least one of the second end of the pole or the second end of the tank is fitted with a second stop. In some embodiments, the first stop includes at least one of a bolt and nut or an instance of an elastomeric material. In some embodiments, the mass includes a core contained within a shell, where the core is made of a first material and the shell is made of a second material, and where the second material is different from the first material. In some embodiments, the core is made of metal and where the shell is made of an elastomer. In some embodiments, the mass is substantially shaped as a sphere. In some embodiments, the system further comprises a pump coupled to the first end of the conduit. In some embodiments, the tank is pressurized to convey the fluid from the second end of the conduit to the first end of the conduit. In some embodiments, the system further comprises a fan drive gear system of a gas turbine engine fluidly coupled to the first end of the conduit to receive at least a portion of the fluid conveyed by the conduit, where the fan drive gear system returns at least a portion of the fluid to a tank inlet of the tank. In some embodiments, the conduit includes a flexible conduit radially inside a protective layer. In some embodiments, the protective layer is an additional conduit, and where the flexible conduit is disposed within the additional conduit such that the conduit is arranged as a tube-within-a-tube.

Aspects of the disclosure are directed to a system comprising: a tank that stores a fluid and includes a tank outlet, and a fluid conduit that includes a conduit inlet at a distal end of the fluid conduit and a conduit outlet at a proximate end of the fluid conduit, where the conduit outlet is located at or proximate the tank outlet, and where the conduit inlet is immersed in the fluid within the tank and the fluid conduit provides fluid flow from the conduit inlet to the conduit outlet, where a first end region of the fluid conduit that extends towards the distal end has a first end region density, where the first end region density is greater than or equal to a fluid density of the fluid such that the conduit inlet remains immersed in the fluid stored in the tank when the fluid in the tank is under negative gravity conditions. In some embodiments, the first end region density is greater than or equal to the fluid density such that the conduit inlet remains immersed in the fluid stored in the tank when the fluid in the tank is under positive gravity conditions, and the conduit inlet moves substantially in unison with the fluid in the tank when the fluid in the tank is subject to a change in gravitational conditions.

### BRIEF DESCRIPTION OF THE DRAWINGS

The present disclosure is illustrated by way of example and not limited in the accompanying figures in which like reference numerals indicate similar elements. The drawing figures are not necessarily drawn to scale unless specifically indicated otherwise.

FIG. 1 is a side cutaway illustration of a geared turbine engine.

FIG. 2A illustrates a system for providing lubricant, where the system is shown during positive-G conditions.

FIG. 2B illustrates the system of FIG. 2A during negative-G conditions.

FIG. 2C illustrates a system for providing lubricant, where the system includes a pole to constrain a movement of a mass.

FIG. 3 illustrates a mass that may be coupled to a conduit in accordance with aspects of this disclosure.

FIG. 4 illustrates a conduit in accordance with aspects of this disclosure.

FIG. 5 illustrates a plot of gravitational conditions versus time in accordance with an exemplary embodiment.

FIG. 6 illustrates a fluid circuit incorporating a fan drive gear system (FDGS) and a tank in accordance with aspects of this disclosure.

### DETAILED DESCRIPTION

It is noted that various connections are set forth between elements in the following description and in the drawings (the contents of which are incorporated in this specification by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities or a space/gap between the entities that are being coupled to one another.

Aspects of the disclosure are directed to apparatuses, systems, and methods associated with an engine. In some embodiments, a conduit having an associated mass may be provided. The conduit may be at least partially located in a tank. A density associated with the conduit may be equal to or greater than a density of a fluid that is present in the tank, such that at least a portion of the conduit (e.g., an end of the conduit) may be positioned/immersed in the fluid within the tank.

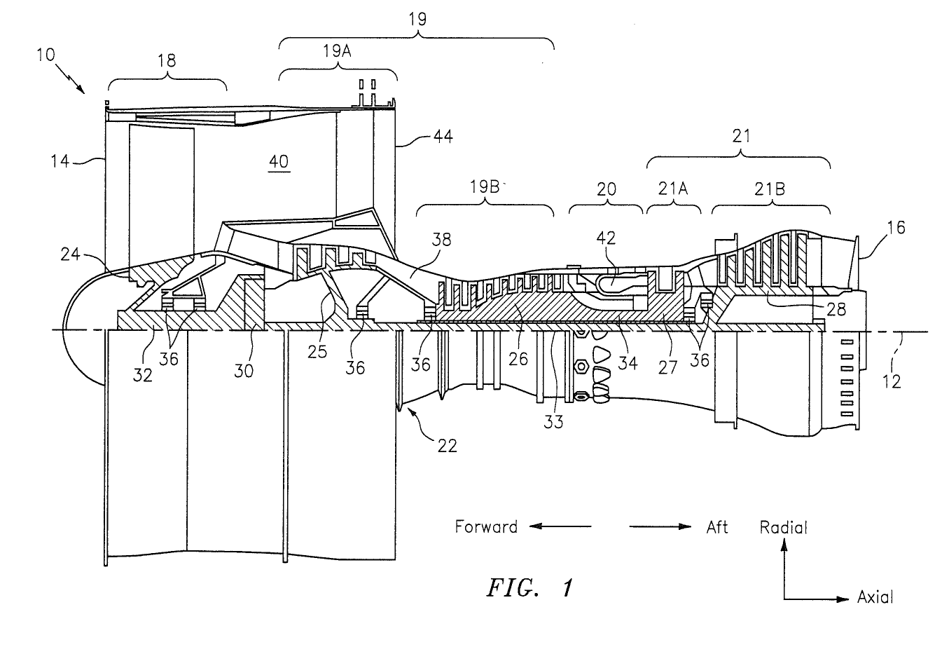

Aspects of the disclosure may be applied in connection with a gas turbine engine. FIG. 1 is a side cutaway illustration of a geared turbine engine 10. This turbine engine 10 extends along an axial centerline 12 between an upstream airflow inlet 14 and a downstream airflow exhaust 16. The turbine engine 10 includes a fan section 18, a compressor section 19, a combustor section 20 and a turbine section 21. The compressor section 19 includes a low pressure compressor (LPC) section 19A and a high pressure compressor (HPC) section 19B. The turbine section 21 includes a high pressure turbine (HPT) section 21A and a low pressure turbine (LPT) section 21B.

The engine sections 18-21 are arranged sequentially along the centerline 12 within an engine housing 22. Each of the engine sections 18-19B, 21A and 21B includes a respective rotor 24-28. Each of these rotors 24-28 includes a plurality of rotor blades arranged circumferentially around and connected to one or more respective rotor disks. The rotor blades, for example, may be formed integral with or mechanically fastened, welded, brazed, adhered and/or otherwise attached to the respective rotor disk(s).

The fan rotor 24 is connected to a gear train 30, for example, through a fan shaft 32. The gear train 30 and the LPC rotor 25 are connected to and driven by the LPT rotor 28 through a low speed shaft 33. The HPC rotor 26 is connected to and driven by the HPT rotor 27 through a high speed shaft 34. The shafts 32-34 are rotatably supported by a plurality of bearings 36; e.g., rolling element and/or thrust bearings. Each of these bearings 36 is connected to the engine housing 22 by at least one stationary structure such as, for example, an annular support strut.

As one skilled in the art would appreciate, in some embodiments a fan drive gear system (FDGS), which may be incorporated as part of the gear train 30, may be used to separate the rotation of the fan rotor 24 from the rotation of the rotor 25 of the low pressure compressor section 19A and the rotor 28 of the low pressure turbine section 21B. For example, such an FDGS may allow the fan rotor 24 to rotate at a different (e.g., slower) speed relative to the rotors 25 and 28.

During operation, air enters the turbine engine 10 through the airflow inlet 14, and is directed through the fan section 18 and into a core gas path 38 and a bypass gas path 40. The air within the core gas path 38 may be referred to as “core air”. The air within the bypass gas path 40 may be referred to as “bypass air”. The core air is directed through the engine sections 19-21, and exits the turbine engine 10 through the airflow exhaust 16 to provide forward engine thrust. Within the combustor section 20, fuel is injected into a combustion chamber 42 and mixed with compressed core air. This fuel-core air mixture is ignited to power the turbine engine 10. The bypass air is directed through the bypass gas path 40 and out of the turbine engine 10 through a bypass nozzle 44 to provide additional forward engine thrust. This additional forward engine thrust may account for a majority (e.g., more than 70 percent) of total engine thrust. Alternatively, at least some of the bypass air may be directed out of the turbine engine 10 through a thrust reverser to provide reverse engine thrust.

FIG. 1 represents one possible configuration for an engine 10. Aspects of the disclosure may be applied in connection with other environments, including additional configurations for gas turbine engines. Aspects of the disclosure may be applied in connection with non-geared engines.

As described above, occasionally an engine (e.g., the engine 10 of FIG. 1) may operate in reduced-G conditions. Such reduced-G conditions may be experienced during a flight on an aircraft. Some areas of the engine, such as the FDGS, may require a relatively non-interrupted supply of lubricant (e.g., may require lubricant in an amount greater than a threshold, potentially as measured over a predetermined period of time).

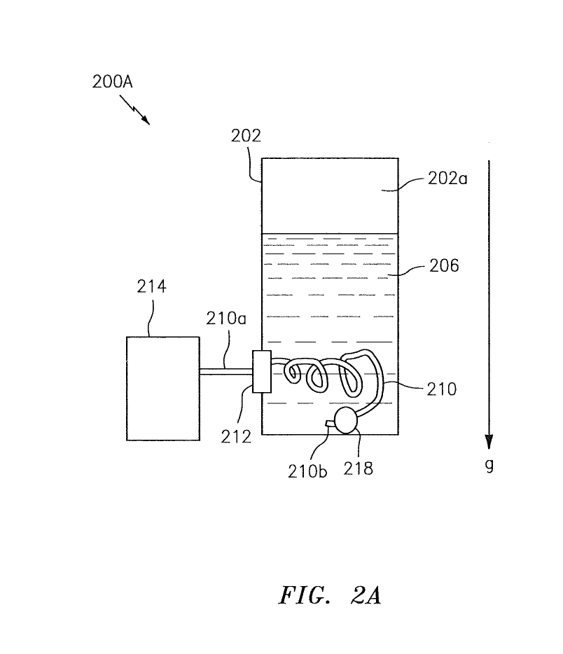

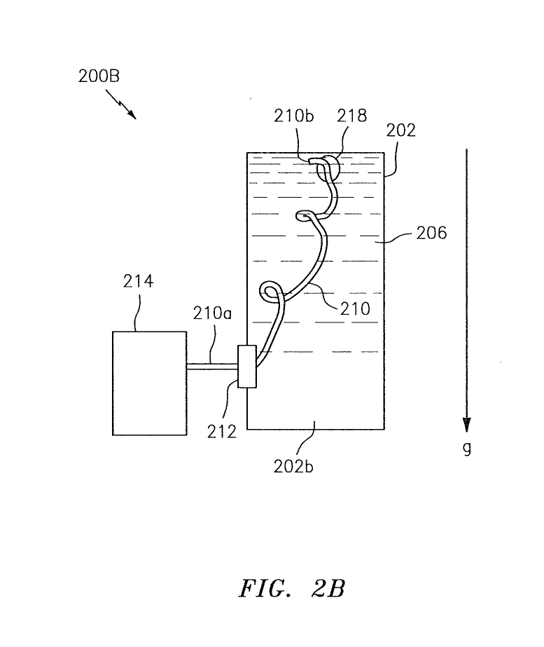

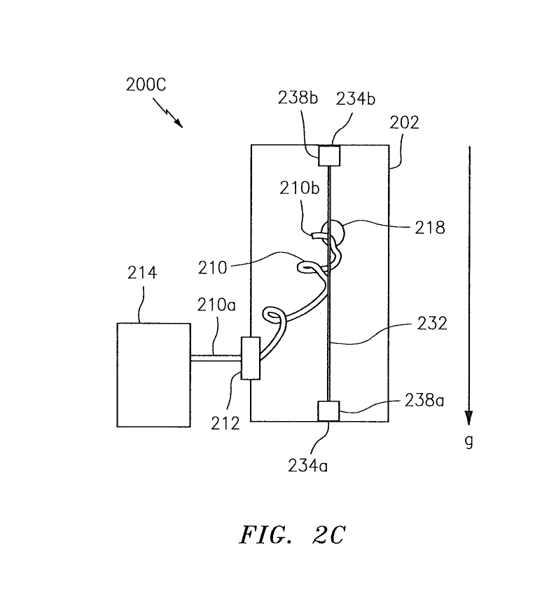

FIG. 2A illustrates a system 200A in accordance with aspects of this disclosure. Superimposed in FIG. 2A is an axis ‘g’, where the direction of the axis is shown with respect to the Earth's gravitational field. In particular, the system 200A is shown under positive-G conditions.

The system 200A may include a tank 202 that may store a quantity/volume of a lubricant 206, where the lubricant 206 may include oil. Due to the positive-G conditions, the lubricant 206 is shown as being biased towards the bottom of the tank 202 in FIG. 2A, such that a portion 202a of the tank 202 located towards the top of the tank 202 may be substantially devoid/free of lubricant.

A conduit 210 may be used to supply at least a portion of the lubricant 206 in the tank 202 to one or more components of the engine. For example, a first end 210a of the conduit 210 may emerge from an outlet 212 of the tank 202 and may be in fluid communication with a mechanism 214, e.g., a pump, where the pump may draw/pull at least a portion of the lubricant 206 from the tank 202 (e.g., the lubricant 206 may be conveyed from a second end/inlet 210b of the conduit 210 to the first end/outlet 210a of the conduit 210). In some embodiments, the tank 202 may be pressurized in order to encourage a flow of lubricant out of the tank 202 (e.g., from the second end 210b of the conduit 210 towards the first end 210a of the conduit 210).

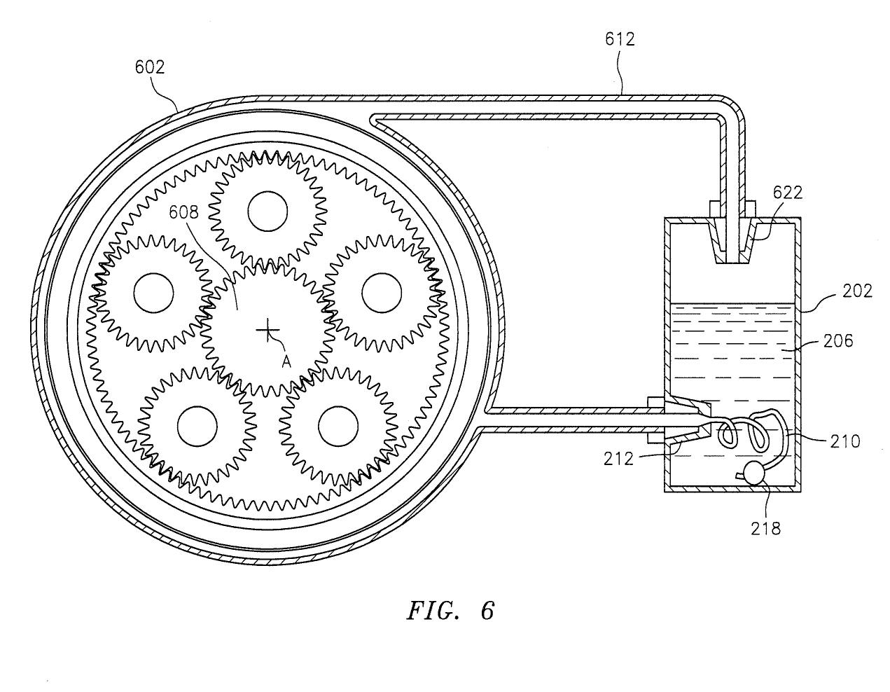

In some embodiments (see FIG. 6), operation of an FDGS 602 (e.g., a rotation of gears 608 included in the FDGS 602) may serve as the mechanism 214 by which the fluid is drawn/pulled from the tank 202. In FIG. 6, the outlet 212 of the tank 202 is shown as fluidly coupled to the FDGS 602. The FDGS 602 may receive/consume at least a portion of the fluid provided from the tank 202 and may return (via an output/outlet 612 of the FDGS) at least a portion of the fluid to an inlet 622 of the tank 202. In this respect, a complete fluid circuit may be established between the tank 202 and the FDGS 602. While FIG. 6 shows the fluid circuit incorporating the tank 202 and the FDGS 602, one skilled in the art would appreciate that the fluid circuit may include additional components/devices. For example, the aforementioned '661 publication describes and illustrates such additional components.

Referring back to FIG. 2A, the second end 210b of the conduit 210 may be positioned within/immersed in the lubricant 206 within the tank 202 in order to ensure that a supply of lubricant is available to, e.g., the mechanism 214. A density of the conduit 210 (or at least a density of the conduit 210 coinciding with the second end 210b) may be selected to be greater than or equal to a density of the lubricant 206 so that the second end 210b is positioned at the bottom of the tank 202 or immersed in the lubricant 206 in FIG. 2A. In some embodiments, a density of the conduit 210/second end 210b may be selected to be up to twenty times greater than a density of the lubricant 206. In some embodiments, a ratio of the density of the conduit 210/second end 210b to a density of the lubricant 206 may be selected to be within a range of: (1) equal to or greater than one and (2) less than or equal to twenty.

In some embodiments, a mass 218 may optionally be included at/proximate the end 210b of the conduit 210. The mass 218 may be included in embodiments where, e.g., a density of the conduit 210 is less than a density of the lubricant 206. Collectively, the density of the conduit 210 and the mass 218 in a region coinciding with the end 210b may be greater than or equal to a density of the lubricant 206. While described separately, the mass 218 may be included/integral with the conduit 210.

While the mass 218 is shown as assuming a (substantially) spherical shape, other shapes for the mass 218 may be used in some embodiments. The mass 218 may be coupled to the conduit 210 using one or more attachment techniques, such as for example using an adhesive, using a fastener (e.g., a bolt and a nut), welding, brazing, bonding, etc.

As described above, the system 200A is shown during positive-G conditions. In comparison, the system 200B of FIG. 2B (where the system 200B may structurally coincide with the system 200A of FIG. 2A) is shown during negative-G conditions (relative to the Earth's gravitational field ‘g’). In such negative-G conditions, the lubricant 206, the end 210b, and the mass 218 (to the extent that the mass 218 is included in some embodiments) are shown as being biased towards the top of the tank 202 in FIG. 2B, such that a portion 202b of the tank 202 located towards the bottom of the tank 202 may be substantially devoid/free of lubricant.

As the relative densities of the conduit 210 (collectively with the mass 218, to the extent that the mass 218 is included) and the lubricant 206 do not change based on whether the system 200A or 200B is operating in positive-G or negative-G conditions, respectively, the end 210b may be positioned within/immersed in the lubricant 206 within the tank 202 in both FIGS. 2A and 2B. The length/span of the conduit 210 may be selected to enable the end 210b/mass 218 to substantially travel the entire length (measured top-to-bottom or bottom-to-top in FIGS. 2A-2B) of the tank 202, as well as reach the furthest corners of the tank (the right-most corners, bottom and top, in FIGS. 2A and 2B, given that the end 210a is shown on the left-most end of the tank 202 in FIGS. 2A and 2B).

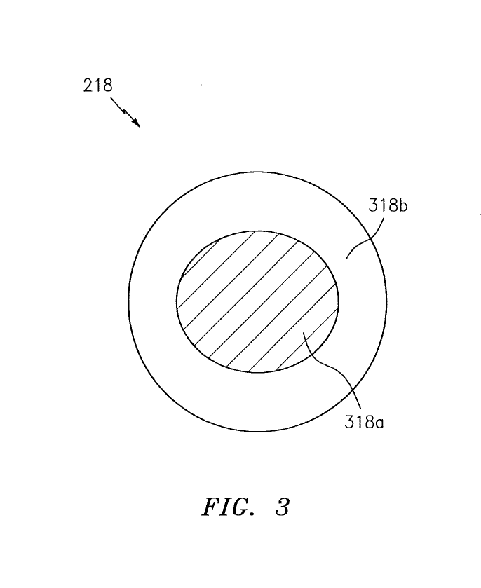

Referring to FIG. 3, in some embodiments the mass 218 may include a core 318a contained within a shell 318b. The core 318a may be made of a first material (e.g., a metal) and the shell 318b may be made of a second material (e.g., an elastomer), the second material being different from the first material. The shell 318b may help to protect the structural integrity of the core 318a and/or the tank 202 (see FIGS. 2A-2B) in the event that the mass 218 contacts the tank 202. For example, the shell 318b may absorb/dissipate any energy associated with the mass 218 impacting a wall/perimeter of the tank 202.

Referring to FIG. 2C, a system 200C is shown. The system 200C may incorporate many of the same components/devices described above in relation to the systems 200A and 200B of FIGS. 2A and 2B, respectively. The system 200C is shown as including a pole/post 232. The pole 232 may be coupled to the tank 202 at a first (distal) end 234a and at a second (distal) end 234b as shown in FIG. 2C. The mass 218 may be coupled to the pole 232, such that movement of the mass 218 may be limited to movement along a length/span of the pole 232 (e.g., lateral movement of the mass 218 within the tank 202 may be substantially prohibited/precluded).

The tank 202/pole 232 may be fitted with a first stop 238a proximate the first end 234a. The tank 202/pole 232 may be fitted with a second stop 238b proximate the second end 234b. The stops 238a and 238b may take one or more forms, such as a bolt and nut, an instance of an elastomeric material, etc. The stops 238a and 238b may prevent the mass 218 from contacting the walls/perimeter of the tank 202 as the mass 218 moves along the pole 232 (where such mass 218 movement may be based on a change in gravitational conditions, e.g., a change from positive-G conditions to negative-G conditions or vice versa).

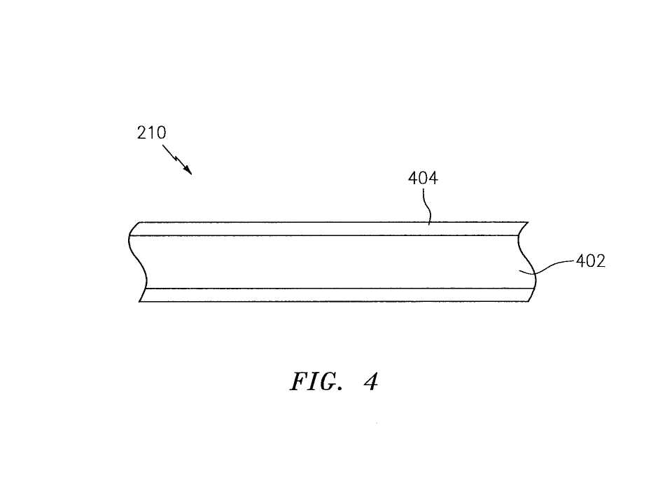

Referring to FIG. 4, an exemplary embodiment of the conduit 210 (see FIGS. 2A-2C) is shown. The conduit 210 may include a flexible conduit 402. The conduit 402 may be radially inside an optional protective layer 404. In some embodiments, the layer 404 may take the form of another conduit (e.g., a conduit in addition to the conduit 402), such that the conduit 210 may be configured as a coaxial conduit/tube (e.g., the conduit 210 may be arranged as a tube-within-a-tube). The layer 404 may contain any lubricant that may escape from the inner conduit 402; this can help to prevent a leak of lubricant in regions outside of the tank 202 (see FIGS. 2A-2C). While the conduit 210 is shown includes two conduits/layers 402 and 404, any number of sub-conduits or layers may be included in some embodiments.

The conduit 402 may be manufactured from an organic polymer. The organic polymer may be capable of withstanding temperatures up to hundreds of Celsius degrees, e.g., 121° C. without being degraded or solubilized by lubricant or by by-products of lubricant degradation. In some embodiments, the organic polymer may have an elastic modulus of about 10⁵ to 10⁶ Pascals at a temperature of, e.g., 65 to 121° C. In some embodiments, the organic polymers used in the conduit 402 may have a glass transition temperature that is greater than 65° C. and a melting point that is greater than 121° C. In an embodiment, the glass transition temperature of the organic polymer is about 65° C. to 121° F., while the melting point of the organic polymer is greater than 121° C. to 232° C.

Organic polymers used in the conduit 402 can be selected from a wide variety of thermoplastic polymers, blends of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, or the like, or a combination comprising at last one of the foregoing organic polymers.

Examples of the organic polymers that can be used in the conduit 402 are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, polytetrafluoroethylene, fluorinated ethylene propylene, perfluoroalkoxyethylene, polychlorotrifluoroethylene, polyvinylidene fluoride, or the like, or a combination thereof.

Examples of thermosetting polymers suitable for use in the conduit 402 include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

In an embodiment, a thermosetting polymer may be an elastomer. Suitable elastomers are polybutadienes, polyisoprenes, styrene-butadiene rubber, poly(styrene)-block-poly(butadiene), poly(acrylonitrile)-block-poly(styrene)-block-poly(butadiene) (AB S), polychloroprenes, epichlorohydrin rubber, polyacrylic rubber, silicone elastomers (polysiloxanes), fluorosilicone elastomers, fluoroelastomers, perfluoroelastomers, polyether block amides (PEBA), chlorosulfonated polyethylene, ethylene propylene diene rubber (EPR), ethylene-vinyl acetate elastomers, or the like, or a combination thereof.

Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like.

In some embodiments, the conduit 402 is manufactured from an elastomer. Exemplary elastomers are silicone elastomers, fluorosilicone elastomers, fluoroelastomers, perfluoroelastomers, or a combination thereof.

The layer 404 may comprise a single or multiple layers of one or more of a metal, a ceramic, or a composite. The layers may be thin enough or ductile enough to permit the conduit 402 to have the desired flexibility (e.g., flexibility in an amount greater than a threshold). Exemplary metals that may be used for the layer 404 include iron, titanium, aluminum, cobalt, nickel, silver, or the like, or a combination thereof. Exemplary composite that may be used for the layer 404 include organic matrix composites, metal matrix composites, ceramic matrix composites, or the like, or a combination thereof.

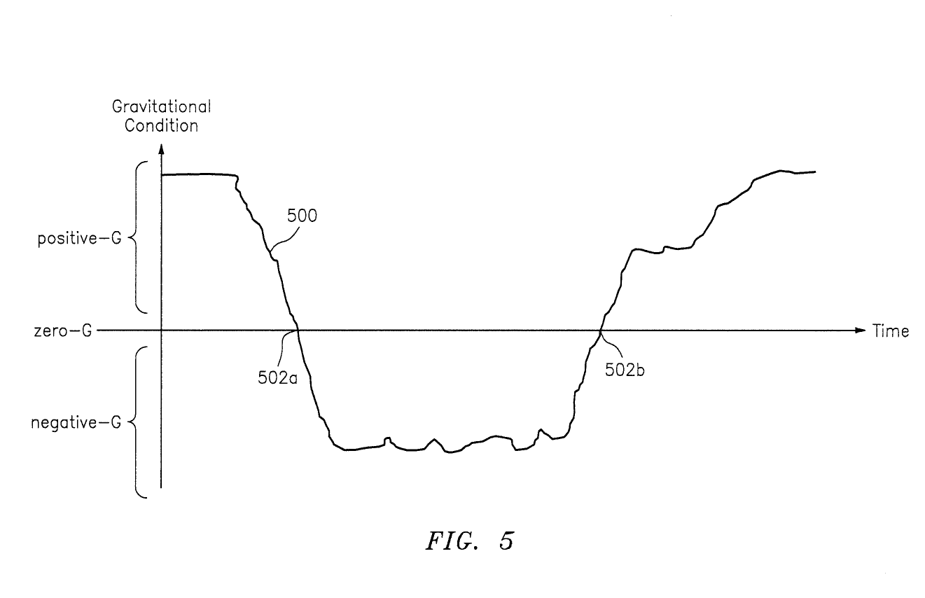

While some of the examples described above in relation to, e.g., FIGS. 2A-2C related to the existence of positive-G conditions or negative-G conditions, aspects of the disclosure may be applied in relation to zero-G conditions. One skilled in the art would appreciate that, as a practical matter, the gravitational condition may spend substantially little time at zero-G conditions in transitioning from, e.g., a positive-G condition to a negative-G condition. For example, FIG. 5 depicts an exemplary plot 500 of the variation of the gravitational condition on the vertical axis versus time on the horizontal axis, where the zero-G condition is shown as occurring at times 502a and 502b. On the other hand, in some instances/scenarios operation in one or more conditions (e.g., zero-G) may persist for extended durations/periods of time.

Technical effects and benefits of this disclosure include an ability to provide at least a threshold amount of a lubricant to one or more components of an engine. The lubricant may be reliably provided during reduced-G conditions, thereby helping to ensure continued operability of the component(s). At least a portion/region of a conduit may move substantially in unison with a fluid stored in a tank during changing gravitational conditions.

While some of the examples described herein related to providing a lubricant to a component, aspects of the disclosure may be used to provide any type of fluid (e.g., any type of liquid) to the component. Examples of such fluids may include hydraulic fluid, fuel (e.g., gasoline), refrigerant, etc.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure. One or more features described in connection with a first embodiment may be combined with one or more features of one or more additional embodiments.

What is claimed is:

1. A system comprising:
a tank that stores a fluid; and
a conduit that includes a first end and a second end,
wherein the conduit is configured to convey at least a portion of the fluid stored in the tank from the second end of the conduit to the first end of the conduit,
wherein a first end region of the conduit coinciding with the second end of the conduit has a first end region density and the fluid has a fluid density,
wherein the first end region density is greater than or equal to the fluid density such that the first end region of the conduit remains immersed in the fluid stored in the tank when the fluid in the tank is under negative gravity conditions.

2. The system of claim 1, wherein the fluid includes at least one of hydraulic fluid, fuel, or refrigerant.

3. The system of claim 1, wherein the fluid includes a lubricant.

4. The system of claim 1, wherein the first end of the conduit is in fluid communication with a mechanism that draws at least a portion of the lubricant from the tank.

5. The system of claim 1, further comprising:
a mass coupled to the second end of the conduit.

6. The system of claim 5, wherein the first end region density is a collective density of a density of the conduit at the second end of the conduit and a density of the mass.

7. The system of claim 5, further comprising:
a pole coupled to the mass, wherein the mass is limited to movement along a span of the pole.

8. The system of claim 7, wherein a first end of the pole is coupled to a first end of the tank, and wherein a second end of the pole is coupled to a second end of the tank.

9. The system of claim 8, wherein at least one of the first end of the pole or the first end of the tank is fitted with a first stop, and wherein at least one of the second end of the pole or the second end of the tank is fitted with a second stop.

10. The system of claim 9, wherein the first stop includes at least one of a bolt and nut or an instance of an elastomeric material.

11. The system of claim 5, wherein the mass includes a core contained within a shell, wherein the core is made of a first material and the shell is made of a second material, and wherein the second material is different from the first material.

12. The system of claim 11, wherein the core is made of metal and wherein the shell is made of an elastomer.

13. The system of claim 5, wherein the mass is substantially shaped as a sphere.

14. The system of claim 1, further comprising:
a pump coupled to the first end of the conduit.

15. The system of claim 1, wherein the tank is pressurized to convey the fluid from the second end of the conduit to the first end of the conduit.

16. The system of claim 1, further comprising:
a fan drive gear system of a gas turbine engine fluidly coupled to the first end of the conduit to receive at least a portion of the fluid conveyed by the conduit;
wherein the fan drive gear system returns at least a portion of the fluid to a tank inlet of the tank.

17. The system of claim 1, wherein the conduit includes a flexible conduit radially inside a protective layer.

18. The system of claim 17, wherein the protective layer is an additional conduit, and wherein the flexible conduit is disposed within the additional conduit such that the conduit is arranged as a tube-within-a-tube.

19. A system comprising:
a tank that stores a fluid and includes a tank outlet; and
a fluid conduit that includes a conduit inlet at a distal end of the fluid conduit and a conduit outlet at a proximate end of the fluid conduit, wherein the conduit outlet is located at or proximate the tank outlet, and wherein the conduit inlet is immersed in the fluid within the tank and the fluid conduit provides fluid flow from the conduit inlet to the conduit outlet;
wherein a first end region of the fluid conduit that extends towards the distal end has a first end region density, wherein the first end region density is greater than or equal to a fluid density of the fluid such that the conduit inlet remains immersed in the fluid stored in the tank when the fluid in the tank is under negative gravity conditions.

20. The system of claim 19, wherein the first end region density is greater than or equal to the fluid density such that the conduit inlet remains immersed in the fluid stored in the tank when the fluid in the tank is under positive gravity conditions, and wherein the conduit inlet moves substantially in unison with the fluid in the tank when the fluid in the tank is subject to a change in gravitational conditions.
